(19) United States
(12) Patent Application Publication
(10) Pub. No.: US 2015/0089389 A1
(43) Pub. Date: Mar. 26, 2015

(54) MULTIPLE MODE MESSAGING

(71) Applicants: Nirit Cohen-Zur, Raanana (IL); Rafi Elad, Hertzeliya (IL)

(72) Inventors: Nirit Cohen-Zur, Raanana (IL); Rafi Elad, Hertzeliya (IL)

(73) Assignee: SAP AG, Walldorf (DE)

(21) Appl. No.: 14/035,365

(22) Filed: Sep. 24, 2013

(51) Int. Cl. H04W 4/12; G06F 3/0482; G06F 3/0487

(52) U.S. Cl. CPC H04W 4/12; G06F 3/0487; G06F 3/0482
USPC 715/752

(57) ABSTRACT

Example systems and methods of facilitating multiple mode messaging are presented. In one example involving a first communication device, a user selection of one of a plurality of message input modes including a text input mode, a graphical input mode, and an audio input mode is received. A user input interface for the selected message input mode is presented. User messaging input is received via the user input interface for the selected message input mode. A user command is received to send the user messaging input as at least one communication service message to a second communication device. In response to the user command, the at least one communication service message is transmitted via a communication network to the second communication device.

### FIELD

This application relates generally to data communication and, in an example embodiment, to multiple mode messaging communications.

### BACKGROUND

Texting, such as by way of Short Messaging Server (SMS) messages transmitted between two cellular phones, continues to be one of the most prevalent methods of mobile communication. Originally, texting via cell phone typically was performed using the standard numeric keys of the keypad of a cell phone, by which multiple letters were assigned to each numeric key. Each letter was typically accessed by way of a number of consecutive presses of its assigned key. To accelerate text entry using the numeric keypad, T-9 (“Text on 9 keys”) was introduced to predict words that a user was typing so that the user may select the word of interest from a list of words generated when the user had only partially entered the word.

With the advent of smartphones and their associated touchscreens for user input, users have been able to enter text for SMS messages using a virtual keyboard presented on the touchscreen. Further enhancing the use of the virtual keyboard has been the introduction of Swype® and similar technologies that allow a user to form words by dragging a finger from letter to letter of the word, lifting the finger from the touchscreen between words. Such technologies then use the word boundaries and the letters identified therebetween to correct minor errors in the entered word by presenting the user with a list of possible words the user may have intended to enter, allowing the user to select one before proceeding to the next word.

In some cases, smartphones have also been equipped with small QWERTY-style physical keyboards that allow users to enter text messages as they would using a desktop or laptop computer.

Regardless of whether a keypad, physical keyboard, or virtual keyboard is employed, a lack of attention to detail in the task of texting often results in misspelled or otherwise erroneous messages being entered and transmitted.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system of communication devices capable of employing the systems and methods described herein;

FIG. 2 is a block diagram of an example communication device of FIG. 1;

FIG. 3 is a flow diagram illustrating an example method of messaging from one communication device to another;

FIG. 4 is a flow diagram illustrating an example method of generating and sending a message;

FIG. 5 is a flow diagram illustrating an example method of receiving and processing a message;

FIG. 6 is a representation of a GUI for entering text for a message to be transmitted;

FIG. 7 is a representation of a GUI for inputting a graphical image for a message to be transmitted;

FIG. 8 is a representation of a GUI for presenting a message thread history including text and image messages;

FIG. 9 is a representation of a GUI for inputting audio for a message to be transmitted;

FIG. 10 is a representation of a GUI for presenting a received message containing audio; and

FIG. 11 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

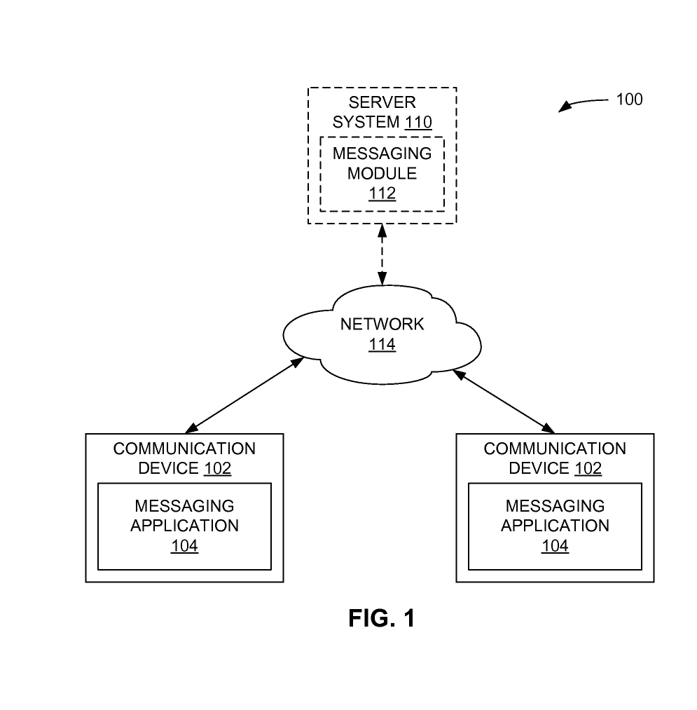

FIG. 1 is a block diagram of an example system 100 of communication devices 102 capable of employing the methods described herein. More specifically, each of the communication devices 102 includes a messaging application 104 that may receive user input of varying modes or types to generate one or more messages for transmission to another communication device 102. Examples of the varying types of input include, but are not limited to, text, graphical or drawing images, audio, and video. Examples of the communication devices 102 may include, but are not limited to, desktop computers, laptop computers, tablet computers, smartphones, personal digital assistants (PDAs), gaming systems, eyeglasses incorporating a lens-based display, and other processing systems capable of executing the messaging application 104. While only two communication devices 102 are depicted in FIG. 1, any number of communication devices 102 may be included in the system 100 to engage in the messaging discussed below.

In one example, the communication devices 102 transmit messages therebetween by way of a communication network 114, such as, for example, a wide-area network (WAN) (e.g., the Internet), a local-area network (LAN) (e.g., an Ethernet network, a Wi-Fi® network, and/or a Bluetooth® network), a cellular network (e.g., 3G (third generation) or 4G (fourth generation) network, or any other communication network capable of carrying the communication messages described herein.

In one example, the communication devices 102 may communicate with each other by way of at least one server system 110 coupled to the network 114. The server system 110 may execute a messaging module 112 that may relay messages between the communication devices 102, as well as perform other processing thereupon, such as buffering, message sender verification, and the like. The server system 110 may also perform one or more of the operations described below as being performed by the messaging application 104 in some implementations to reduce the amount of processing performed in the communication devices 102. In one example, the server system 110 may exist in the form of a cloud computing system capable of supporting the transfer and possible processing of large volumes of messaging data.

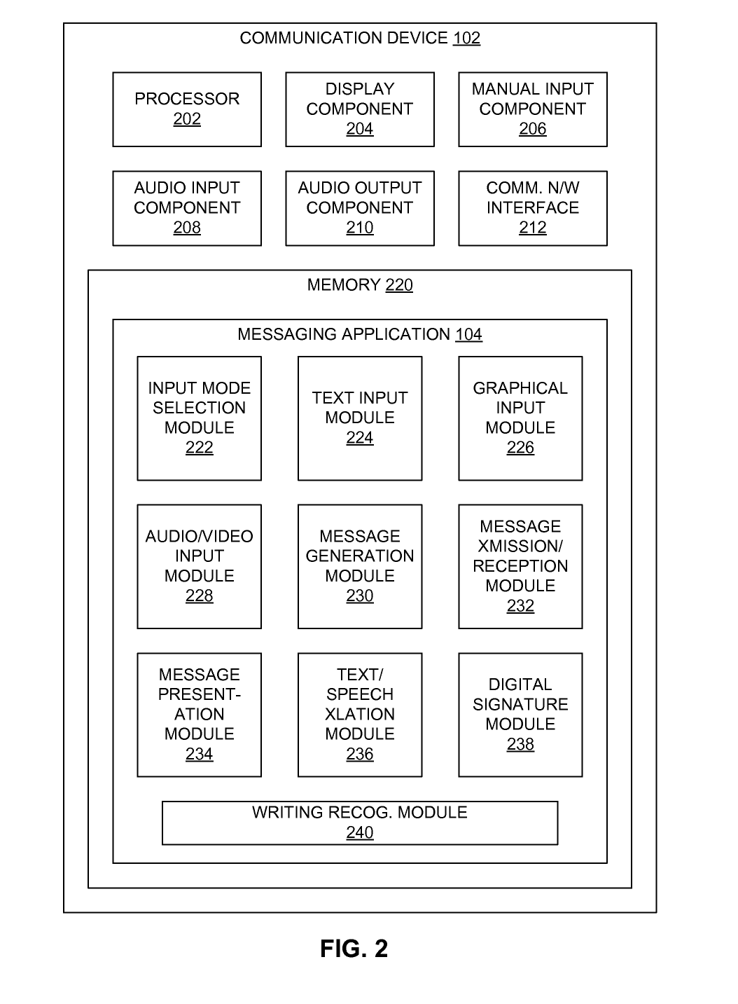

FIG. 2 is a block diagram of an example of the communication device 102 of FIG. 1. As depicted in FIG. 2, the communication device 102 may include at least one processor 202, a display component 204, a manual input component 206, an audio input component 208, an audio output component 210, a communication network interface 212, and memory 220. Other components, such as a power supply, may be included in the communication device 102 in other implementations. In the memory 220 may be stored the messaging application 104 of FIG. 1, which may include, for example, an input mode selection module 222, a text input module 224, a graphical input module 226, an audio/video input module 228, a message generation module 230, a message transmission/reception module 232, a message presentation module 234, a text/speech translation module 236, a digital signature module 238, and a writing recognition module 240. The messaging application 104 may also include other modules not explicitly depicted in FIG. 2, or may include fewer modules than shown. Also, several of the modules 222-240 of FIG. 1 may be combined into fewer modules or separated into a greater number of modules.

The processor 202 may be at least one microprocessor, microcontroller, or other hardware processing device capable of executing the messaging application 104 and interacting with the other components 204-220 of the communication device 102. The display component 204 may be a cathode ray tube (CRT), a liquid crystal display (LCD), a touchscreen, or the like for displaying a GUI to the user of the communication device 102. The manual input component 206 may be a keyboard, a joystick, a touchpad, a touchscreen that also serves as the display component 204, or any other input component that can receive manual input from the user of the communication device 102 for generating one or more messages. The audio input component 208 may be a microphone or similar component for entering audio for a message, while the audio output component 210 may be one or more speakers or similar audio-producing components for providing audio associated with an incoming message. The communication network interface 212 may be any communication network interface that communicatively couples the communication device 102 with the network 114 of FIG. 1.

In the messaging application 104, the input mode selection module 222 facilitates user selection, by way of a GUI, of a particular mode of input for populating or generating a message to be transmitted. As mentioned above, the different modes of input entry may include, for example, text entry (e.g., by way of a physical or virtual keyboard), image, handwriting, and/or drawing entry (e.g., by way of a touchscreen (with or without the benefit of a stylus), joystick, or other positional input component), and audio entry (e.g., via a microphone). Upon receiving a user selection of one of the modes of input entry provided via the input mode selection module 222, a module corresponding to the selected input mode may then be employed to facilitate user entry of the corresponding message data associated with that input mode. In the example of FIG. 2, the text input module 224 may receive and process text the user enters via a physical or virtual keyboard, the graphical input module 226 may receive and process image, handwriting, and/or drawing data the user enters via a joystick or touchscreen, and the audio/video input module 228 may receive and process audio, video, and/or still image data the user provides via a microphone and/or a camera. In one example, a different GUI may be presented to the user for each of the different forms of user input to be entered. In some implementations, multiple forms of input may be provided for insertion into a single unified message or group of messages to be transmitted.

The message generation module 230 may collect the user input provided via the text input module 224, the graphical input module 226, and the audio/video input module 228 to generate the one or more messages to be transmitted. In one implementation, the message generation module 230 may generate one or more communication service messages, such as one or more SMS and/or MMS (Multimedia Messaging Service) messages, for transmission. Further, these messages may be generated automatically without direct involvement from the user, based solely on the particular input provided by the user via any of the GUIs associated with the various types of allowable user input. For example, the user need not explicitly attach image or audio files to the message prior to transmission.

The message transmission/reception module 232 may transmit and receive the messages described above via the communication network interface 212 and the communication network 114. The message transmission/reception module 232 may also perform retries of transmitted messages that were transmitted unsuccessfully, provide acknowledgment of successfully received messages, provide notice of unsuccessfully received messages, and perform other operations commensurate with the transmission and reception of the messages.

The message presentation module 234 may present received messages via a GUI to the user. In one example, for messages including one or more of text, graphic, and audio data, the message presentation module 234 may generate a single GUI presenting all included data forms to the user, a separate GUI for each different type of data provided in the message, or some combination thereof. The message presentation module 234 may also provide a display of multiple messages of a particular message thread between the communication device 102 and another communication device 102.

The text/speech translation module 236 may convert audible speech included in a received message to text, and/or convert text received in a message to audible speech. In one example, the text/speech translation module 236 may perform such operations automatically, or may perform these operations in response to an explicit request from the user. In some examples, the text/speech translation module 236 may also perform optical character recognition (OCR) on handwritten messages provided in graphical form to a text version of the message, and possibly translate the generated text to provide an audible speech version of the data. In one example, the text/speech translation module 236 may convert text to speech, or speech to text, for incoming messages that have been received at the communication device 102, and/or for outgoing messages prior to their transmission from the communication device 102.

The digital signature module 238 may encrypt generated message data prior to transmission using a digital signature associated with a user of the communication device 102 to provide enhanced security of the message. Correspondingly, the digital signature module 238 may also decrypt messages that have been encrypted with a digital signature associated with a sending user.

The writing recognition module 240 may compare a received message that includes image or drawing data, such as handwritten script or characters, with characteristic samples of one or more users of other communication devices 102, and determine with some level of accuracy whether the purported sender of the message is likely to have written the received message. The writing recognition module 240 may employ one or more algorithms for handwriting analysis or graphology software for this purpose.

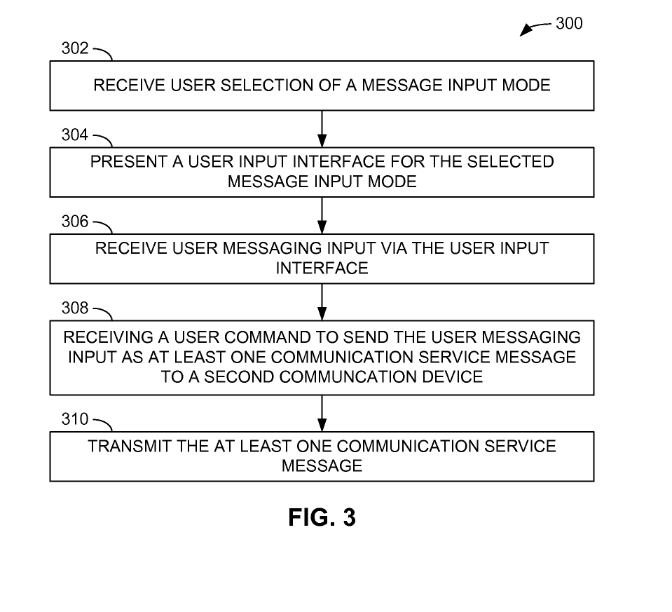

FIG. 3 is a flow diagram illustrating an example method 300 of messaging from one communication device to another. While the various operations of the method 300 are described in reference to the communication device 102 and included messaging application 104 of FIG. 2, other devices or systems may be employed to perform the method 300 in other embodiments.

In the method 300, a user selection of a message input mode is received (operation 302) at the input mode selection module 222. A user input interface is presented for the selected message input mode (operation 304) via the text input module 224, the graphical input module 226, or the audio/video input module 228. User messaging input is received via the presented user input interface (operation 306). A user command to send the user messaging input as at least one communication service message to a second communication device is then received (operation 308). The at least one communication service message is transmitted to the second communication device (operation 310).

While the operations 302 through 310 of the method 300 of FIG. 3 are shown in a specific order, other orders of operation, including possibly concurrent or continual execution of at least portions of one or more operations, may be possible in some implementations of method 300, as well as other methods discussed herein.

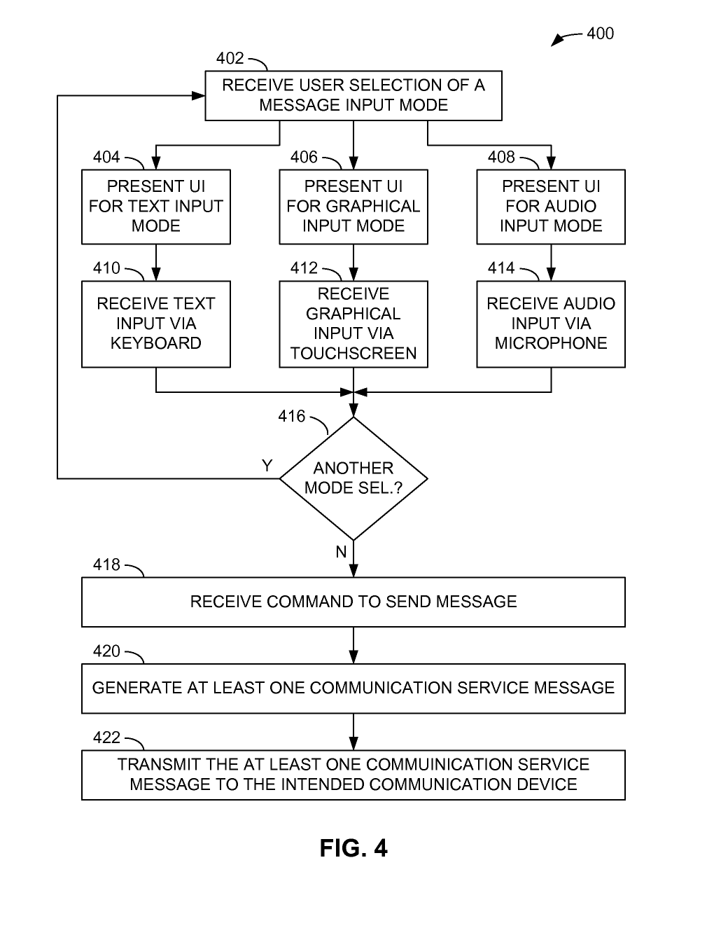

FIG. 4 is a flow diagram illustrating an example method 400 of generating and sending a message. In the method 400, the input mode selection module 222 receives a user selection of a message input mode (operation 402). In this example, three message input modes are available: a text input mode, a graphical input mode, and an audio input mode. In other embodiments, additional or alternative input modes, such as a video input mode and/or a still image input mode, may be included. In response to a user selection of one of these modes, a corresponding user interface for the selected input mode is presented to the user. More specifically, if the user selects the text input mode, the input mode selection module 222 may provide a text input GUI serviced by the text input module 224 (operation 404). If the user selects the graphical input mode, the input mode selection module 222 may provide a graphical input GUI serviced by the graphical input module 226 (operation 406). If, instead, the user selects the audio input mode, the input mode selection module 222 may provide an audio input GUI serviced by the audio/video input module 228 (operation 408). Examples of each of these GUIs are described in greater detail below.

Each of the text input module 224, the graphical input module 226, and the audio/video input module 228 may then receive the appropriate message input from the user for the selected mode. For example, for the text input mode, the input mode selection module 222 may receive text input (operation 410) from the user by way of a physical or virtual keyboard presented in the text input GUI. For the graphical input mode, the graphical input module 226 may receive graphical input (operation 412) from the user by way of a touchscreen, mouse, joystick, or similar device via the graphical input GUI. For the audio input mode, the audio/video input module 228 may receive audio input (operation 414) from the user via a microphone accessible via the audio input GUI. In other examples, the audio/video input module 228 may receive video data from the user via a camera (possibly along with audio data via the microphone) via a video or audio/video input GUI. Still images captured via the camera may also be employed via a still image input GUI.

If the input mode selection module 222 detects that the user is providing another mode selection (operation 416), the input mode selection module 222 receives the new input mode selection (operation 402), presents the corresponding GUI for the selected input mode (operations 404, 406, and 408), and receives the corresponding input from the user (operations 410, 412, and 414) to be added to the same message or group of messages. If, instead, the message generation module 230 receives a command to send the message to another communication device 102 (operation 418), the message generation module 230 generates at least one communication service message, such as one or more SMS and/or MMS messages, based on the input provided by the user (operation 420). In some examples, additional processing of the one or more messages, such as, for example, encryption via the digital signature module 238, may also be provided. In some embodiments, the text/speech translation module 236 may translate audio input data into text, or translate input text data into audio data, before the individual messages are generated. Other processing of the input data may also be performed in other implementations. The message transmission/reception module 232 may then transmit the resulting one or more messages via the communication network interface 212 and the network 114 to the intended receiving communication device 102 (operation 422).

In some examples, the method 400 may also include processing operations performed on the

[symbol]

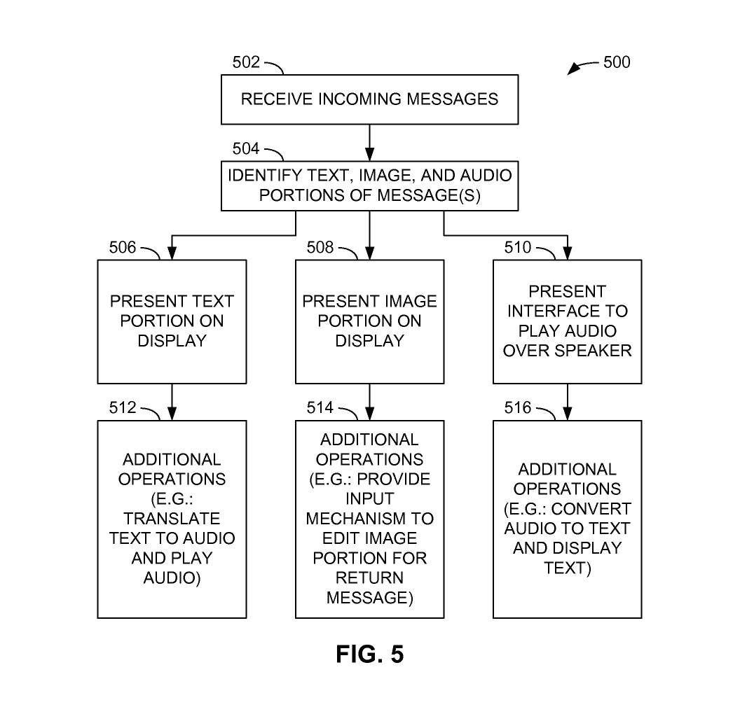

FIG. 5 is a flow diagram illustrating an example method 500 of receiving and processing a message. In the method 500, the message transmission/reception module 232 may receive one or more incoming messages from another communication device 102 (operation 502). As part of the reception process, the digital signature module 238 may decrypt all or a portion of the received data from the one or more incoming messages based on a digital signature of a user associated with the communication device 102 sourcing the one or more messages.

The message presentation module 234 may then identify any text, image, and/or audio portions of the messages (operation 504) and present those portions via respective portions of a message presentation GUI. For example, the message presentation module 234 may present text data carried in the one or more received messages in a text portion of a GUI (operation 506), may present image data in the one or more messages in an image portion of the GUI (operation 508), and may present an interface in the GUI to allow the user to access audio data in the one or more messages (operation 510). In one example, the GUI in which the various types of data may be presented may be limited to a single GUI screen or page, or may be distributed across multiple screens or pages, possibly depending on the total amount of data in the messages, the amount of each data for each mode (e.g., text, image, or audio), and other factors.

For each of the different types or forms of message data presented, the message presentation module 234, possibly in conjunction with other modules of the messaging application 104, may provide other operations or processing involving that data. In one example, for text data, the text/speech translation module 236 may translate the text to audio and subsequently play the audio via a speaker of the communication device 102 (operation 512). For image data, the graphical input module 226 may provide the user with the ability to edit the image data so that the edited image data may then be provided in another outgoing message, such as a return message to the communication device 102 from which the image data was originally received (operation 514). In another example, the writing recognition module 240 may determine an identity of a user that generated handwriting in the image data, such as by way of graphology or other handwriting analysis. For audio data, the text/speech translation module 236 may translate the audio data to text data and display the text data to the user (operation 516). The messaging application 104 may employ other additional operations for one or more of the different types of received message data in other embodiments.

Further, as indicated above, other types of data, such as still image and/or video data, may be identified and presented on the display. Moreover, additional operations for processing such data, such as facial recognition, may be applied to the still image and/or video data in the received messages.

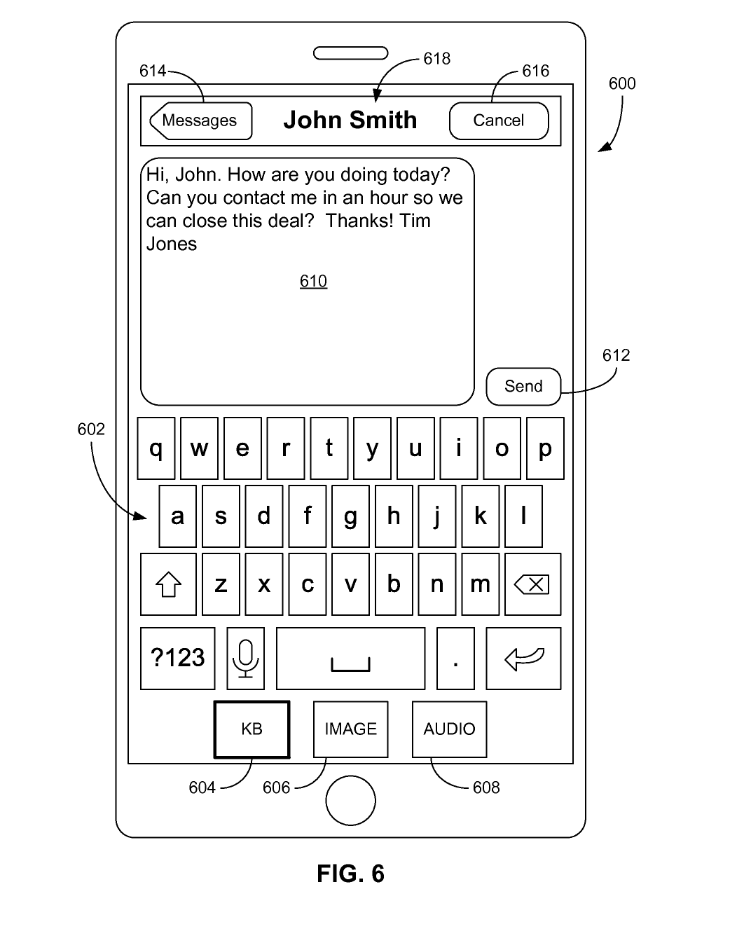

FIGS. 6-10 are graphical representations of various GUIs provided by the messaging application 104 to facilitate the generation, transmission, reception, and presentation of messages including multiple types of data, such as text, image, and audio data. Each of these representations is depicted on a smartphone touchscreen. However, any communication device, including desktop, laptop, and tablet computers, for example, may provide corresponding GUIs in other implementations.

FIG. 6 is a representation of a GUI 600 on a communication device 102 for entering text for a message to be transmitted to another communication device 102. In the GUI 600, three input mode buttons 604, 606, and 608 are provided, by which a user may select one of three input modes: text input mode via a text mode (“KB”) button 604, graphical input mode (including handwriting) via a graphical mode (“image”) button 606, and audio input mode via an “audio” button 608. As further explained above, the GUI 600 may also provide additional input mode buttons, such as a video (and/or audio/video) mode button and a still image button mode button. As illustrated in FIG. 6, the text mode button 604 is active, indicating that the GUI 600 is provided for text input. To that end, the GUI 600 presents a virtual keyboard 602 for user entry of alphanumeric and supplemental characters. Also provided is a text window 610 that displays the entered text to the user. In another example, the GUI 600 may provide additional functionality not specifically depicted in FIG. 6, such as spell-check and/or grammar-check functionality.

If the user decides during text entry that the message is complete and ready for transmission, the user may activate a send button 612 in the GUI 600 for that purpose. As discussed above, in one example, the messaging application 104 may generate more than one SMS or MMS message containing any text, images, audio and so forth included in the message, but the user of the communication device 102 will view the operation as a single message, without the need to attach images files or perform other ancillary operations prior to sending the message. Similarly, when such a message is received at the receiving communication device 102, the receiving communication device 102 may open at least some of the received messages or files and present them to the corresponding user without requiring the user to manually open those messages or files.

At the top of the GUI 600 is an identifier 618 for a user (“John Smith”) or entity to which the one or more messages are to be transmitted. In some examples, the message to be transmitted is one of a chain or thread of messages passed between two communication devices 102, with the particular thread being identified by way of the identifier 618. To return to a list of such threads, or to a list of messages in general, the GUI 600 provides a “messages” back button 614. Also, to cancel data entry in the current GUI 600 and begin data entry anew, the user may activate a “cancel” button 616.

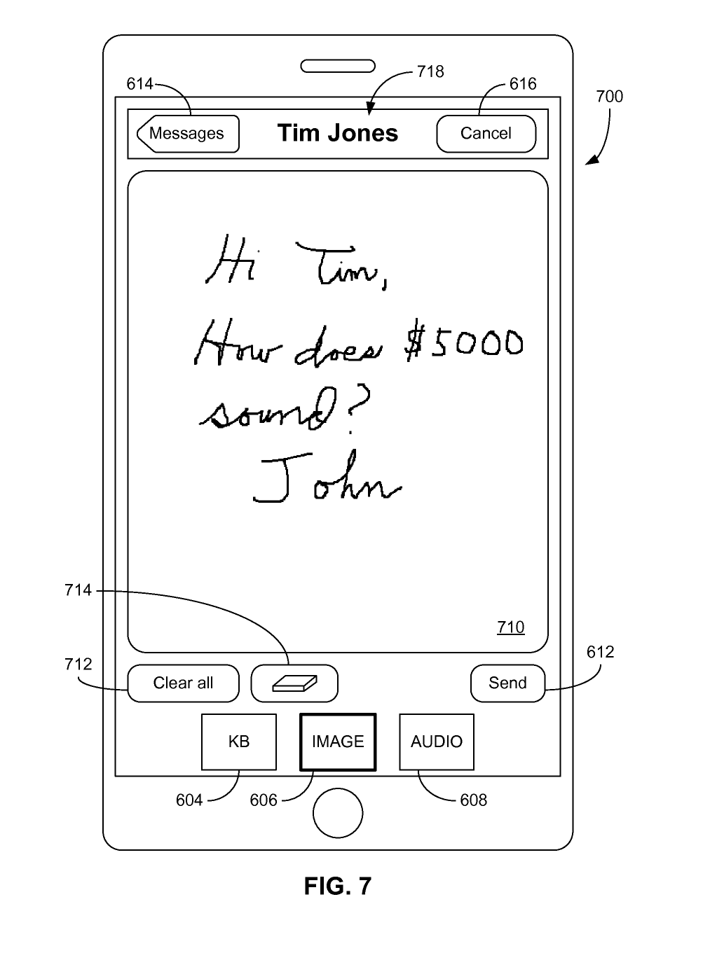

FIG. 7 is a representation of a GUI 700 for inputting a graphical image for a message to be transmitted. As shown in FIG. 7, the recipient of the message of FIG. 6 is generating a message to be transmitted to the author of the original message, as indicated by the identifier 718 (“Tim Jones”) provided in the GUI 700. The GUI 700 may be displayed in response to the user activating the graphical mode button 606, as shown in FIG. 7. Consequently, instead of displaying a virtual keyboard, the messaging application 104 may present a graphical input area 710 in which the user may draw or write an image, such as a handwritten note, using a stylus, finger, or other indicator, to be included in the message. The GUI 700 also includes a “clear all” button 712 to clear the graphical input area 710 to allow input of the graphical data to begin again. The GUI also provides an eraser button 714 that, when activated, allows the user to clear portions of the graphical input area 710 of the user's selection, such as by way of a finger, stylus, or the like. If the user desires to send the image and other data supplied for the message, the user may initiate transmission via the send button 612.

In one example, the graphical input area 710 may simply provide the user with the ability to produce a binary image file, in which each pixel or other portion of the image is either black or white, with the white area serving as a background, and the black areas indicating places the user has made contact with the graphical input area 710. In other examples, the GUI 700 may provide the user with additional functionality for generating the image, such as, for example, additional editing tools (e.g., cropping, resizing, etc.), multiple colors from which to choose, multiple “brush” types or thicknesses, and the like.

In some examples, the image may be based upon a preexisting image, such as a map retrieved from the Internet, a photo captured at the communication device 102 or elsewhere, an image received in a message from another communication device 102, and so on, that has been selected by the user. In response to the user selecting such an image, the messaging application 104 may place such an image in the graphical input area 710, and the user may edit the image (e.g., by adding symbols and/or text to the image, by drawing or writing on the image, etc.) before issuing the command to transmit the edited image to the intended recipient. Moreover, the image may be one that is transmitted back and forth among a group of two or more communication devices 102, with each user editing the image before passing the image along to another one of the communication devices 102.

In some instances, the image may constitute a significant amount of data. As a result, the messaging module 112 of the server system 110 (FIG. 1) may store at least portions of the image in the server system 110 or in another system accessible by the communication device 102 via the network 114.

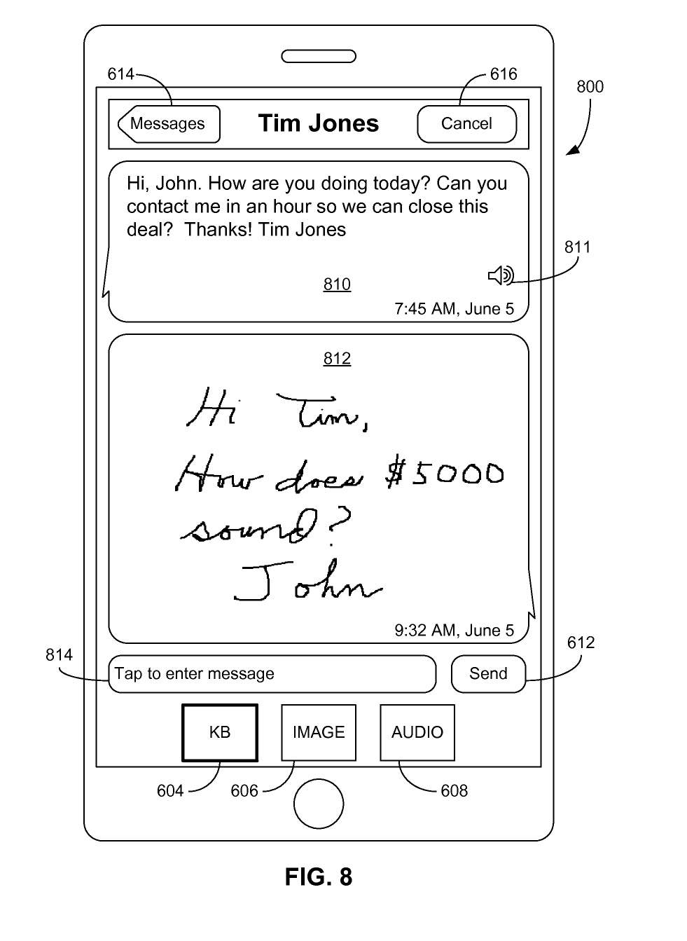

FIG. 8 is a representation of a GUI 800 for presenting a message thread history including text and image messages. In this example, the message from John Smith illustrated in FIG. 7 has been transmitted. In response to the transmission of that message, the communication device 102 of John Smith may present in the GUI 800 the resulting message thread, displaying the original typed message from Tim Jones shown in FIG. 6 in a first window 810, and the responding image-oriented message from John Smith depicted in FIG. 7 in a second window 812, possibly with corresponding date and time stamps.

To allow more than one message of a message thread to be displayed, the messaging application 104 may alter or modify the appearance of the original image shown in the second window 812 by any of a number of methods, such as resizing, cropping, and so on. To see the message restored to its original form, the user may activate the second window 812, which may then present the image in a separate GUI (not shown in FIG. 8).

In addition to the text of the first message, the first window 810 may also provide an audio icon 811. In response to the user activating the audio icon 811, the messaging application 104 may translate the text in the first window 810 into audio data and play the audio data on the speaker of the communication device 102.

In the particular example of FIG. 8, the GUI 800, by default, presents the previous messages in a text input window, in which the text input mode button 604 is activated, and in which a text entry field 814 is presented. If the user taps the text entry field 814, the messaging application 104 may present the text input GUI shown in FIG. 6. If, instead, the user activates the graphical mode button 606 or the audio mode button 608, the messaging application 104 may display the associated input entry GUI (e.g., the GUI 700 for graphical input, as depicted in FIG. 7) for the activated button.

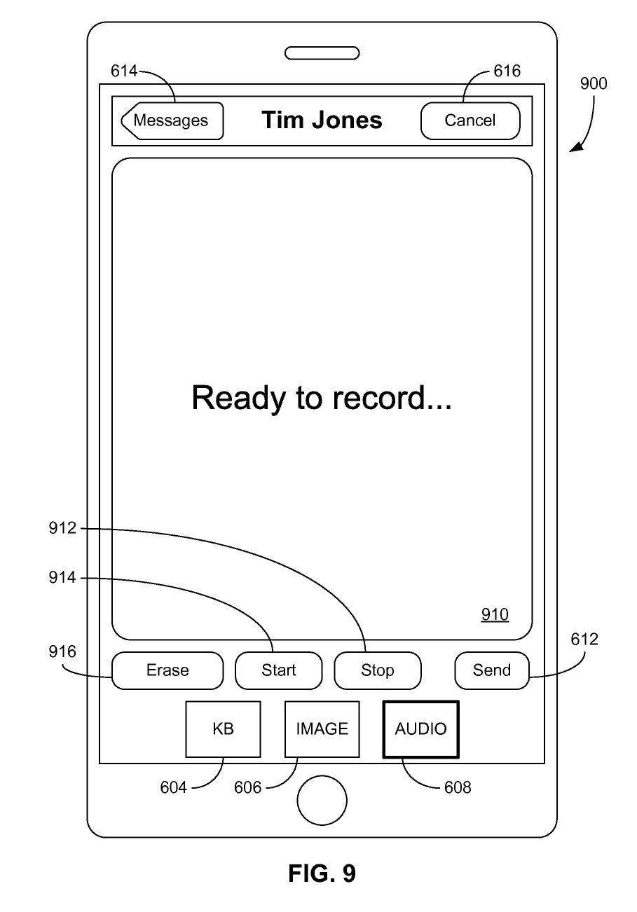

FIG. 9 is a representation of a GUI 900 for inputting audio for a message to be transmitted. In response to the user activating the audio mode button 608, the messaging application 104 may present the GUI 900 to allow the user to record audio, such as a spoken message, for transmission to another communication device 102. The user may then activate a start button 914 to being recording, a stop button 912 to stop or pause the recording, and an erase button 916 to erase what has been recorded. Once the user is satisfied with the recorded message, the user may then initiate transmission of the message by activating the send button 612, or may add text or image data to the message by activating the text mode button 604 or the graphical mode button 606, respectively. In the example of FIG. 9, the user (John Smith) has activated the audio mode button 608 instead of the graphical mode button 606, as discussed with respect to FIG. 7.

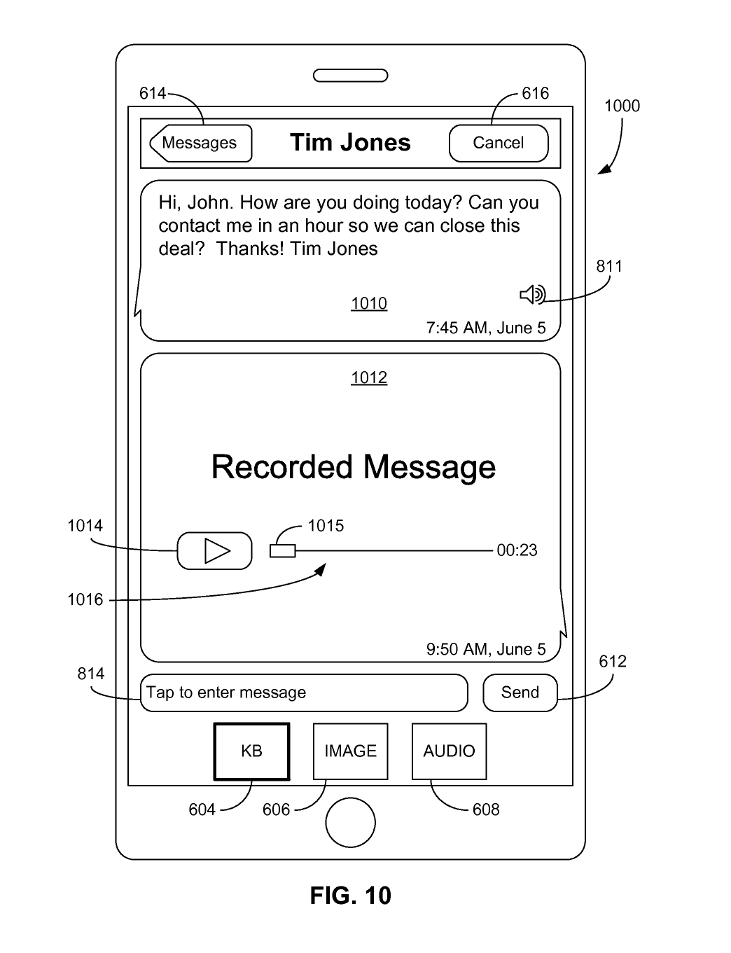

FIG. 10 is a representation of a GUI 1000 for presenting a received message containing text and audio messages. Similar to the GUI 800 of FIG. 8, the messaging application 104 in this example has transmitted the audio message from John Smith illustrated in FIG. 9. In response to the transmission of that message, the communication device 102 of John Smith may present in the GUI 1000 the resulting message thread, displaying the original typed message from Tim Jones shown in FIG. 6 in a first window 1010, and the responding audio message from John Smith depicted in FIG. 9 in a second window 1012, with corresponding date and time stamps.

To review the message that was sent, the user may activate a play button 1014. To adjust the point at which playback of the audio message commences, the user may manipulate a progress indicator 1015 of a playback timeline 1016, which may also shown the total length of the message. As with the GUI 800 of FIG. 8, the GUI 1000 also presents the previous messages in a default text input window, in which the text input mode button 604 is activated, and in which a text entry field 814 is presented.

As a result of at least some of the embodiments described above, a messaging application executing on a communication device may facilitate the transmission and reception of multiple mode input, such as text, graphics, audio, still images, and/or video. From the standpoint of the user composing the message, one or more of the types of input may be included in a single “message,” which may then be transmitted as one or more communication service messages, such as SMS and/or MMS messages, chat service messages, and so on, without assembling multiple files manually prior to transmission of the message.

Further, the ability to input one or more of multiple data types may facilitate the generation of less error prone, more easily generated and understood messages. For example, while text entry is often fraught with misspelled words, typographical errors, and the like, a graphical handwritten message may be easier and faster to generate, as the user does not have to navigate a small virtual keyboard, thus eliminating the need for switching from one language character set to another, from alphabetical to numeric and/or symbolic keys, from upper-case to lower-case letters, and so on. Accordingly, users need not devote significant attention or manual accuracy when providing a handwritten message. Also, the receiving user may consider the resulting handwritten image to be more readable. Additionally, the receiving user may verify the author of the message via the handwriting or drawing style exhibited in the message, thus possibly lending some measure of security. Of course, graphical entry is not limited to handwriting, but may instead include drawings or sketches, edited versions of preexisting drawings or photos, and the like, thus expanding the number of ways a user may communicate using a messaging application, thereby improving user satisfaction by providing a user-friendly and more personally configurable mechanism for generating and delivering messages.

Also, a user may instead generate an audio, video, and/or still image message with little actual contact with the communication device, thus simplifying the process of engaging in messaging, especially when taking part in other activities, such as walking or driving. Further, reception of such messages may be welcomed by users that are more comfortable listening to audible speech or viewing images compared to reading text messages (e.g., by older and/or disabled individuals, or by young children not yet able to read and/or write). In addition, the message application may include additional functionality, such as speech-to-text and/or text-to-speech capability to allow receiving users to consume messages in a form with which they are most comfortable.

While the various embodiments of the messaging application described above are presented as a standalone application operating on a communication device, the messaging application may be executed at least partially on a separate system, such as the server system 110 of FIG. 1, to reduce consumption of the storage and/or processing resources in the communication device. Further, the message application may serve as part of a larger application to provide a messaging capability within the execution environment of the larger application.

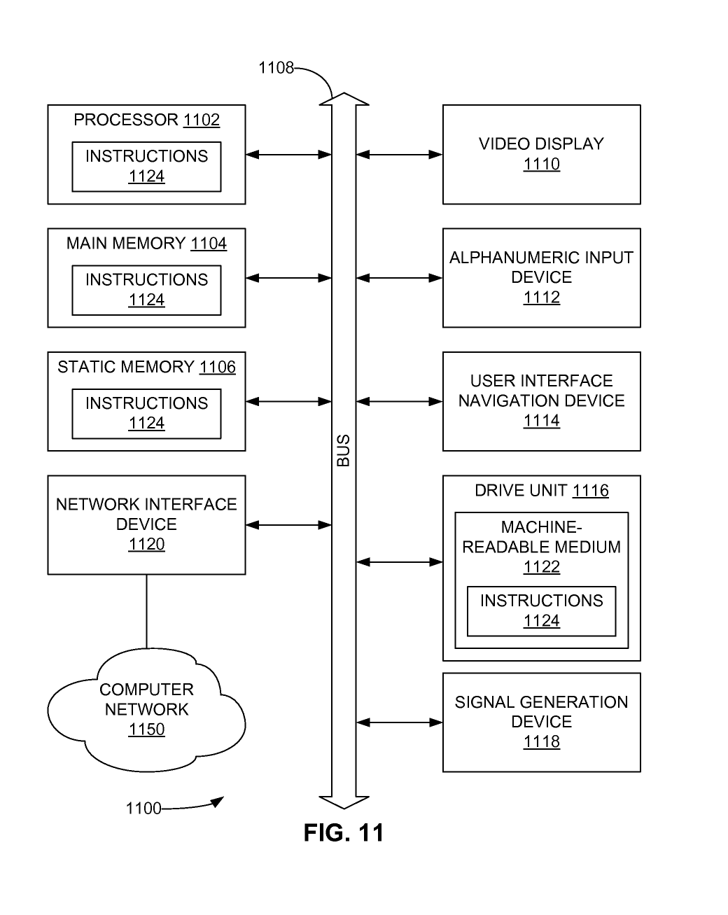

FIG. 11 depicts a block diagram of a machine in the example form of a processing system 1100 within which may be executed a set of instructions 1124 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions 1124 (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 1100 includes a processor 1102 (e.g., a central processing unit (CPU), a graphics processing unit (GPU), or both), a main memory 1104 (e.g., random access memory), and static memory 1106 (e.g., static random-access memory), which communicate with each other via bus 1108. The processing system 1100 may further include video display unit 1110 (e.g., a plasma display, a liquid crystal display (LCD), or a cathode ray tube (CRT)). The processing system 1100 also includes an alphanumeric input device 1112 (e.g., a keyboard), a user interface (UI) navigation device 1114 (e.g., a mouse), a disk drive unit 1116, a signal generation device 1118 (e.g., a speaker), and a network interface device 1120.

The disk drive unit 1116 (a type of non-volatile memory storage) includes a machine-readable medium 1122 on which is stored one or more sets of data structures and instructions 1124 (e.g., software) embodying or utilized by any one or more of the methodologies or functions described herein. The data structures and instructions 1124 may also reside, completely or at least partially, within the main memory 1104, the static memory 1106, and/or within the processor 1102 during execution thereof by processing system 1100, with the main memory 1104, the static memory 1106, and the processor 1102 also constituting machine-readable, tangible media.

The data structures and instructions 1124 may further be transmitted or received over a computer network 1150 via network interface device 1120 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 1100) or one or more hardware modules of a computer system (e.g., a processor 1102 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 1102 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 1102 that is configured using software, the general-purpose processor 1102 may be configured as respective different hardware modules at different times. Software may accordingly configure a processor 1102, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 1102 that are temporarily configured (e.g., by software) or permanently configured to perform the relevant operations. Whether temporarily or permanently configured, such processors 1102 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 1102 or processor-implemented modules. The performance of certain of the operations may be distributed among the one or more processors 1102, not only residing within a single machine but deployed across a number of machines. In some example embodiments, the processors 1102 may be located in a single location (e.g., within a home environment, within an office environment, or as a server farm), while in other embodiments, the processors 1102 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method of facilitating multiple mode messaging, the method comprising:
receiving, at a first communication device, a user selection of one of a plurality of message input modes comprising a text input mode, a graphical input mode, and an audio input mode;
presenting, at the first communication device, in response to the receiving of the user selection, a user input interface for the one of the plurality of message input modes;
receiving, at the first communication device, user messaging input via the user input interface for the one of the plurality of message input modes;
receiving, at the first communication device, a user command to send the user messaging input as at least one communication service message to a second communication device; and
transmitting, by at least one processor of the first communication device via a communication network, the at least one communication service message to the second communication device in response to the receiving of the user command.

2. The method of claim 1, wherein:
the user selection comprises a selection of the graphical input mode;
the method further comprises saving, at the first communication device, the user messaging input in an image file in response to the receiving of the user command; and
the transmitting of the at least one communication service message comprises transmitting the image file to the second communication device as at least a portion of the at least one communication service message.

3. The method of claim 2, wherein the plurality of message input modes further comprises at least one of a video input mode and a still image input mode.

4. The method of claim 2, further comprising:
receiving, at the first communication device prior to the receiving of the user command, a user selection of the image file;
displaying, at the first communication device, the image file in response to the user selection; and
adding, at the first communication device, the user messaging input to the image file.

5. The method of claim 4, further comprising:
capturing, at the first communication device, a photographic image; and
saving, at the first communication device, the photographic image as the image file.

6. The method of claim 1, wherein:
the user selection comprises a selection of the audio input mode;
the method further comprises saving, at the first communication device, the user messaging input in an audio file in response to the receiving of the user command; and
the transmitting of the at least one communication service message comprises transmitting the audio file to the second communication device as at least a portion of the at least one communication service message.

7. The method of claim 1, further comprising:
receiving, at the first communication device, after the receiving of the user messaging input and prior to the receiving of the user command, a second user selection of a second one of the plurality of message input modes;
presenting, at the first communication device, in response to the receiving of the second user selection, a second user input interface for the second one of the plurality of message input modes; and
receiving, at the first communication device, second user messaging input via the user input interface for the second one of the plurality of message input modes, the second user messaging input to be included in the at least one communication service message.

8. The method of claim 1, further comprising:
encrypting, at the first communication device, the user messaging input using a digital signature corresponding to the first communication device.

9. The method of claim 1, further comprising:
receiving, at the first communication device, at least one incoming communication service message from the second communication device, the at least one incoming communication service message comprising an image file;
presenting, at the first communication device, an image represented in the image file in the user input interface for the graphical input mode;
receiving, at the first communication device, second user messaging input comprising editing of the image file;
editing, at the first communication device, the image file based on the second user messaging input;
receiving, at the first communication device, a second user command to send the image file as at least one other communication service message to the second communication device; and
transmitting, from the first communication device via the communication network, the at least one other communication service message to the second communication device in response to receiving the second user command.

10. The method of claim 1, further comprising:
receiving, at the first communication device, at least one incoming communication service message from the second communication device, the at least one incoming communication service message comprising an audio file; and
playing, at the first communication device, the audio file.

11. The method of claim 1, further comprising:
receiving, at the first communication device, at least one incoming communication service message from the second communication device, the at least one incoming communication service message comprising text data;
converting, at the first communication device, the text data into audio data; and
playing, at the first communication device, the audio data.

12. The method of claim 11, further comprising:
displaying, at the first communication device, the text data and an audio play indicator corresponding to the text data; and
receiving, at the first communication device, a user selection of the audio play indicator;
wherein the converting of the text data into audio data and the playing of the audio data occur in response to the receiving of the user selection of the audio play indicator.

13. The method of claim 1, further comprising:
receiving, at the first communication device, at least one incoming communication service message from the second communication device, the at least one incoming communication service message comprising an image file;
presenting, at the first communication device, an image represented in the image file; and
analyzing, at the first communication device, the image file to determine an identity of a user who generated the image file.

14. The method of claim 13, wherein:
the image file comprises handwritten text; and
the analyzing of the image file comprises analyzing the handwritten text to determine the identity of the user who generated the image file.

15. A computer-readable storage medium comprising instructions that, when executed by at least one processor of a first communication device, cause the first communication device to perform operations comprising:
receiving a user selection of one of a plurality of message input modes comprising a text input mode, a graphical input mode, and an audio input mode;
presenting, in response to the receiving of the user selection, a user input interface for the one of the plurality of message input modes;
receiving user messaging input via the user input interface for the one of the plurality of message input modes;
receiving a user command to send the user messaging input as at least one communication service message to a second communication device; and
transmitting, via a communication network, the at least one communication service message to the second communication device in response to the receiving of the user command.

16. A communication device comprising:
a display component;
a manual input component;
an audio input component;
a communication network interface;
at least one processor; and
memory comprising instructions that, when executed by the at least one processor, cause the at least one processor to perform operations comprising:
receiving, via the manual input component, a user selection of one of a plurality of message input modes comprising a text input mode, a graphical input mode, and an audio input mode;
presenting, via the display component, in response to the receiving of the user selection, a user input interface for the one of the plurality of message input modes;
receiving user messaging input from a user for the one of the plurality of message input modes, the user messaging input being received via the manual input component based on the one of the plurality of message input modes being the text input mode or the graphical input mode, the user messaging input being received via the audio input component based on the one of the plurality of message input modes comprising the audio input mode;
receiving, via the manual input component, a user command to send the user messaging input as at least one communication service message to a second communication device; and
transmitting, via the communication network interface, the at least one communication service message to the second communication device in response to the receiving of the user command.

17. The communication device of claim 16, wherein:
the display component and the manual input component are combined as a touchscreen component.

18. The communication device of claim 16, wherein:
the manual input component comprises a graphical input component.

19. The communication device of claim 18, wherein:
the manual input component further comprises a keyboard.

20. The communication device of claim 16, wherein:
the user selection comprises a selection of the graphical input mode;
the operations further comprise saving the user messaging input in an image file in response to the receiving of the user command; and
the transmitting of the at least one communication service message comprises transmitting the image file to the second communication device as at least a portion of the at least one communication service message.
